(19) United States
(12) Patent Application Publication
(10) Pub. No.: US 2011/0033753 A1
(43) Pub. Date: Feb. 10, 2011

(54) ELECTRODE FOR LITHIUM BATTERY AND ITS MANUFACTURING METHOD, AND LITHIUM BATTERY

(75) Inventor: Sukenori ICHIKAWA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/838,676

(22) Filed: Jul. 19, 2010

(30) Foreign Application Priority Data
Aug. 5, 2009 (JP) 2009-182413

(51) Int. Cl. H01M 4/58; H01M 4/82

(52) U.S. Cl. 429/231.95; 29/623.1

(57) ABSTRACT

A lithium battery electrode includes: a metal body having a wiring shape; and a layer of active material disposed on a surface of the metal body having a wiring shape.

The entire disclosure of Japanese Patent Application No. 2009-182413, filed Aug. 5, 2009 is expressly incorporated by reference herein.

### BACKGROUND

1. Technical Field

The present invention generally relates to electrodes for lithium batteries and methods for manufacturing the same, and lithium batteries.

2. Related Art

Lithium batteries using lithium or lithium containing material as negative electrodes are not only light in weight and large in capacity, but also capable of providing high voltages when combined with appropriate positive electrodes. For this reason, lithium batteries are widely used as batteries for portable electronic equipment, cameras, watches, electric tools, hybrid automobiles and the like.

However, such lithium batteries may use highly active lithium and organic electrolyte, which cause for concern about their dangers, such as, firing and explosion at the time of short-circuits. Therefore, it is an important issue in designing lithium batteries to secure their safety. Also, deterioration of lithium secondary batteries that take place with charging and discharging of the batteries also poses problems, and it is desired to extend their service life against greater charge-discharge cycles.

With this as background, the use of spinel lithium titanate crystal (Li₄Ti₅O₁₂) as negative electrode active material has been proposed as a technology to secure the safety of the batteries and improve the battery cycle life (for example, see Japanese Laid-open Patent Applications HEI 7-335261, 2001-143702 and 2005-100770). The aforementioned spinel lithium titanate crystal (Li₄Ti₅O₁₂) has an electron conductivity of about 10⁻⁸ S/cm in terms of dielectric property. However, when the spinel lithium titanate crystal (Li₄Ti₅O₁₂) is used as the negative electrode active material, it absorbs Li ions through charging, its electron conductivity elevates (to about 10⁻² S/cm), and its crystal type also changes to rock salt type Li₇Ti₅O₁₂ crystal.

On the other hand, when rock salt type crystal (Li₇Ti₅O₁₂) is used as the negative electrode active material, even when an internal short-circuit occurs, Li migrates from the rock salt type Li₇Ti₅O₁₂ crystal in the portion where the short-circuit occurs, and the crystal changes into insulating Li₄Ti₅O₁₂ crystal. Then, short-circuit current cannot flow any further at that portion, such that heat generation does not occur and therefore firing would not occur.

When this type of lithium titanate crystals is used, there is no volume change that could result from the change in crystal structure between the spinel type and the rock salt type, which considerably improve the battery cycle life against charging and discharging (see, for example, Japanese Laid-open Patent Application 2001-210328).

Lithium titanate is inferior in conductivity, and therefore it is necessary to mix with conductive additive particles such as acetylene black and carbon black when used as active material. However, mere addition and mixing of the conductive additive with the active material may not achieve sufficient contacts between the active material and the conductive additive or between the conductive additive and the collector electrode. As a result, this may partially generate portions of the active material where electrons generated in the active material by the electrode reaction are not collected by the collector electrode, whereby the utilization factor of the active material is lowered and thus the desired output cannot be obtained.

### SUMMARY

In accordance with an advantage of some aspects of the invention, it is possible to provide electrodes for lithium batteries and methods for manufacturing the same, which can make up for the shortage of conductivity of active material such as lithium titanate, and improve the utilization factor of active material, thereby achieving higher power output of lithium batteries, and it is also possible to provide lithium batteries with higher power output.

In accordance with an embodiment of the invention, an electrode body for lithium battery includes a metal body having a wiring shape, and a layer of active material disposed on a surface of the metal body having a wiring shape.

According to the electrode body for lithium battery described above, the layer of active material is disposed on the surface of the metal body having a wiring shape, such that electrons generated in the electrode reaction in the active material are transferred through the metal body having a wiring shape and are well collected by a collector electrode, whereby the utilization factor of the active material is increased and therefore a higher power output can be achieved by a lithium battery that uses the electrode.

In the electrode body for lithium battery, the active material may preferably cover the metal body having a wiring shape. By so doing, the amount of the active material per the metal body having a wiring shape increases, whereby higher power output and greater capacity can be achieved by a lithium battery using the electrode.

In the electrode body for lithium battery, the metal body having a wiring shape may preferably be made of a titanium wire, and the active material may preferably be made of lithium titanate. Accordingly, for example, an outer layer of the metal body having a wiring shape made of a titanium wire may be oxidized, and the oxidized layer may further be reacted with lithium salt, whereby the active material composed of lithium titanate can be generated.

Also, in the electrode body for lithium battery, the metal body having a wiring shape may preferably form a woven fabric. As the metal body having a wiring shape, for example, a metal wire is formed into a woven fabric, metal bodies having a wiring shape readily become conductively connected with one another, such that electrons generated in the electrode reaction in the active material can be transferred through the metal bodies having a wiring shape and better collected by the collector electrode. Also, as the metal bodies having a wiring shape are formed into a woven fabric whose handling is easy, manufacturing of lithium batteries using such a woven fabric of metal bodies having a wiring shape becomes easier.

In the electrode body for lithium battery, the metal body having a wiring shape may preferably have a line diameter of 1 μm or greater. As a result, electrons generated in the electrode reaction in the active material can be better conducted through the metal body having a wiring shape.

Further, in the electrode body for lithium battery, a plurality of the woven fabrics of metal bodies having a wiring shape may preferably be laminated to the collector electrode. By so doing, a lithium battery using the electrode body can achieve higher power output and greater capacity.

In accordance with another embodiment of the invention, a method for manufacturing an electrode for lithium battery includes the steps of oxidizing a metal body having a wiring shape by an anodic oxidization method, thereby forming a metal oxide layer at an outer layer of the metal body having a wiring shape, submerging the metal body having a wiring shape with the metal oxide layer formed thereon in an aqueous solution containing an active material or a material for forming the active material to cause a hydrothermal synthesis reaction on the metal oxide layer, thereby generating the active material on the surface of the metal body having a wiring shape.

According to the method for manufacturing an electrode body for lithium battery, the active material can be generated and disposed on the surface of the metal body having a wiring shape whose central portion remains unoxidized. Accordingly, with the electrode for lithium battery, electrons generated in the electrode reaction in the active material can be transferred through the metal body having a wiring shape and collected well by the collector electrode, whereby the utilization factor of the active material becomes higher and a lithium battery using the electrode can achieve higher power output.

According to the method for manufacturing an electrode body for lithium battery, the active material may preferably be generated into a state to cover the metal body having a wiring shape. By so doing, in the obtained electrode for lithium battery, the amount of the active material per the metal body having a wiring shape increases, whereby a lithium battery using the electrode can achieve higher power output and greater capacity.

In the method for manufacturing an electrode body for lithium battery, a titanium wire may preferably be used as the metal body having a wiring shape and a lithium salt aqueous solution may preferably be used, and lithium titanate may preferably be generated as the active material. By so doing, the active material composed of lithium titanate can be readily generated by oxidizing an outer layer of the metal body having a wiring shape made of a titanium wire, and further having the oxidized layer reacted with lithium salt.

In this case, the lithium salt aqueous solution may preferably have pH of 10 or greater. By so doing, the active material composed of lithium titanate can be more favorably generated.

Also, in the method for manufacturing an electrode body for lithium battery, metal bodies having a wiring shape formed into a woven fabric may preferably be used. As a result, in an electrode for lithium battery obtained, as the metal bodies having a wiring shape are formed into a woven fabric, the metal bodies having a wiring shape readily become conductively connected to one another, such that electrons generated in the electrode reaction in the active material can be transferred through the metal bodies having a wiring shape and more favorably collected by the collector electrode. Also, as the metal bodies having a wiring shape are formed into a woven fabric whose handling is easy, manufacturing of lithium batteries using such woven fabrics of metal bodies having a wiring shape becomes easier.

Further, in the method for manufacturing an electrode body for lithium battery, when the metal body having a wiring shape is oxidized by an anodic oxidation method, the central section remained metallic without being oxidized may preferably have a diameter of 1 μm or greater. By so doing, in the obtained electrode for lithium battery, electrons generated in the electrode reaction in the active material can well be conducted through the metal body.

A lithium battery in accordance with an embodiment of the invention includes any one of the electrodes for lithium battery described above or an electrode for lithium battery manufactured by any one of the manufacturing methods described above. As the lithium battery includes the electrode for lithium battery in which electrons generated in the electrode reaction in the active material can be transferred through the metal body having a wiring shape and collected well by the collector electrode, and the utilization factor of the active material is greater, as described above, higher power output can be achieved.

### BRIEF DESCRIPTION OF THE DRAWINGS

FIG. 1 is a schematic view of a structure of an electrode for lithium battery in accordance with an embodiment of the invention.

FIG. 2 is a schematic view of a lithium battery in accordance with an embodiment of the invention.

FIG. 3 is a plan view showing a metal woven fabric body.

FIG. 4 is a plan view of a metal woven fabric body after anodic oxidation.

FIG. 5 is a view showing a state in which the metal woven fabric body shown in FIG. 4 is submerged in a lithium salt aqueous solution.

### DESCRIPTION OF EXEMPLARY EMBODIMENTS

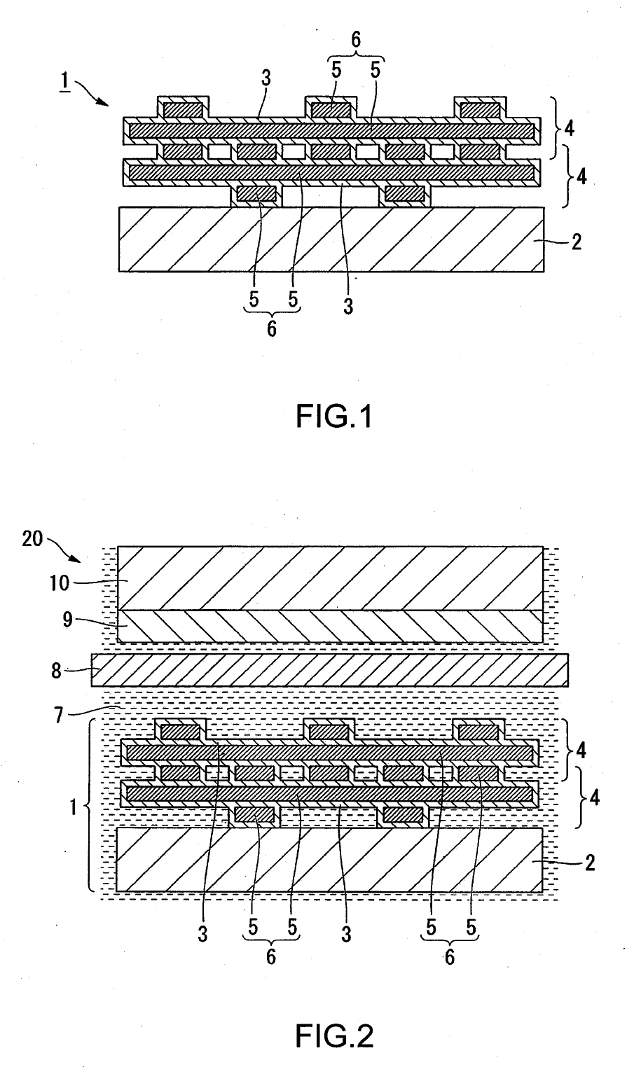

Embodiments of the invention are described in detail below with reference to the accompanying drawings. First, an electrode for a lithium battery (hereafter also referred to as a lithium battery electrode) in accordance with an embodiment of the invention is described. FIG. 1 is a side cross-sectional view showing a schematic structure of a main portion of the lithium battery electrode in accordance with the embodiment of the invention. Reference number 1 in FIG. 1 denotes a lithium battery electrode (hereafter also abbreviated as a battery electrode).

The battery electrode 1 is equipped with a plate-like (or a foil-like) collector electrode 2, and an active material body 4 that is in contact with one surface side of the collector electrode 2 and includes an active material layer 3 composed of active material. The battery electrode 1 may be used as a negative electrode of a lithium secondary battery (a lithium battery) to be described below. The collector electrode 2 is made of a conductive thin plate material (or a foil material), such as, carbon, Cu, Ni, Ti, Al, stainless steel or the like, and for example, may preferably be formed from a carbon tape. Also, the collector electrode 2 is connected to wiring (not shown).

The active material body 4 is formed from a metal woven fabric body 6 in a woven fabric state (a mesh state) in which metal bodies having a wiring shape (fibrous metal bodies) 5 are woven into a fabric, and the active material 3 that is provided in one piece with the outer layer of the metal body 5 composing the metal woven fabric body 6, and covers the entirety of the metal body 5. As the metal body 5, titanium bodies having a wiring shape, in other words, titanium wires may preferably be used. Therefore, in accordance with the present embodiment, the metal bodies having a wiring shape 5 are formed from titanium wires. Also, the titanium wires are woven into a mesh, thereby forming the metal woven fabric body 6.

However, the metal woven fabric body 6 composed of titanium wires has an active material formed at its outer layer by a chemical reaction, as described below, thereby forming the active material layer 3. Accordingly, the titanium wire as an original material has a fiber diameter, for example, between about 2 μm and about 20 μm, but a metal portion (a portion of titanium) of the wire after the active material layer 3 has been formed, in other words, a central portion of the wire which is not chemically reacted, may preferably have a diameter, for example, between about 1 μm and about 10 μm. If the diameter of the central section is less than 1 μm, electrons generated in the electrode reaction in the active material layer 3 may not be conducted well through the central section. If the diameter of the central section is greater than 10 μm, the amount of the active material layer 3 is relatively reduced, which would harm implementation of higher power output and greater capacity of the battery.

As the metal woven fabric body 6 composed of titanium wires, commercially available products can be used as the original material. Further, the original material may preferably be in a square shape with each side being about several mm or greater. It is noted that the metal body 5 is not limited to titanium, and any other metal, that can be a material for forming the active material, may be used.

The active material layer 3 may be formed from lithium titanate, such as, Li₄Ti₅O₁₂, Li₇Ti₅O₁₂, or the like. The active material 2 is formed at the outer layer of the metal woven fabric body 6, as a result of chemical reaction of the metal woven fabric body 6 composed of the aforementioned titanium wires, as described below. In other words, the active material 3 covers and coats the entire metal portion (the central portion) in the metal woven fabric body 6, whereby the active material 3 is given a sufficient surface area. If a metal other than titanium is used as the metal body 5, an appropriate active material other than lithium titanate may be used for composing the active material layer 3.

The active material body 4 with this composition is bonded and affixed to one side surface of the collector electrode 2 through, for example, conductive binder (not shown), as shown in FIG. 1. Also, multiple layers of the active material bodies 4 may be laminated through conductive binder (not shown), whereby higher power output and greater capacity can be achieved.

The battery electrode 1 equipped with the active material layer bodies 4 is combined with a positive electrode that is made of a positive electrode active material layer 9 and a collector electrode 10 provided on the side of the active material layer bodies 4 through a separator 8, for example, as shown in FIG. 2, and an electrolyte 7 is filled between the collector electrode 2 and the collector electrode 10, thereby forming a lithium battery 20.

As the electrolyte 7, a solution in which LiPF₆ is dissolved in a solvent prepared by mixing, for example, propylene carbonate and dimethyl ether at a volume ratio of 1:1, and is adjusted to a concentration of 1 mol/liter, may be used.

As the separator 8, a microporous film made of, for example, polyolefin, can be used. As the positive electrode active material, lithium cobaltate (LiCoO₂), lithium nickelate (LiNiO₂), lithium manganate (LiMn₂O₄), and the like may be used. As the collector electrode 9, an electrode similar to the collector electrode 2 can be used.

Next, based on the method for manufacturing the battery electrode 1 shown in FIG. 1, a method for manufacturing an electrode for a lithium battery in accordance with an embodiment of the invention is described.

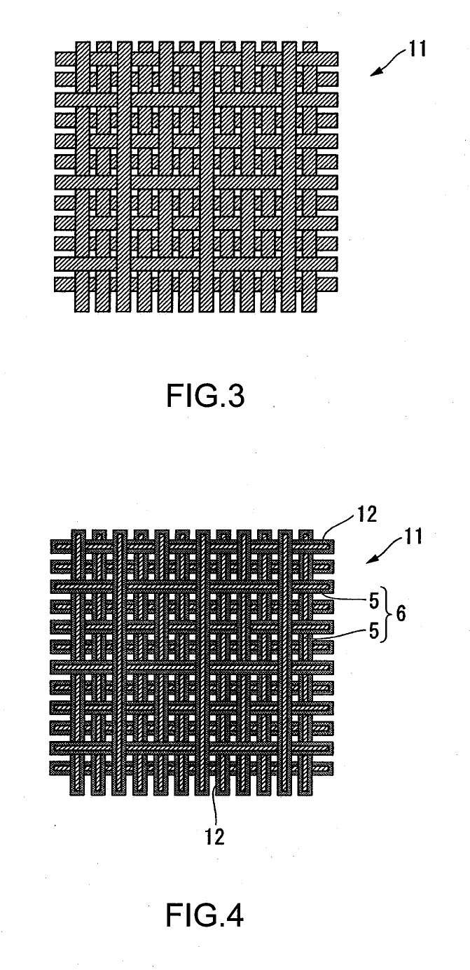

First, a metal woven fabric body 11 composed of titanium wires (metal bodies having a wiring shape) is prepared, as shown in FIG. 3. For the metal woven fabric body 11, titanium wires having a wire diameter between about 2 μm and about 20 μm may be used. The metal woven fabric body 11 having a square shape with each side having a length of, for example, about several mm or greater, may preferably be used, as handling of the fabric body having such a size is easy. It is noted that commercially available products may be used as the metal woven fabric body 11.

Next, the metal woven fabric body 11 is oxidized by an anodic oxidation method, whereby only its outer layer is oxidized to form a titanium oxide (titania) layer 12, without oxidizing its central portion, as shown in FIG. 4. The formed titanium oxide layer 12 may be amorphous or crystalline. Also, in the case of crystalline, the titanium oxide layer 12 may be in any of anatase, rutile or brookite structure.

The central portion that remains to be metal (titanium) without being oxidized may be formed to have a diameter between about 1 μm and about 10 μm, as described above. The metal woven fabric body 6 composed of the metal bodies having a wiring shape 5 shown in FIG. 1 is formed from such central portions that remain to be metal (titanium). The film thickness of an oxide film to be formed can be readily controlled by the anodic oxidation method, such that the diameter of the central portion can be readily adjusted by subtracting the thickness of the titanium oxide layer 12 to be formed from the line diameter of the titanium wire that is the raw material for the metal woven fabric body 11.

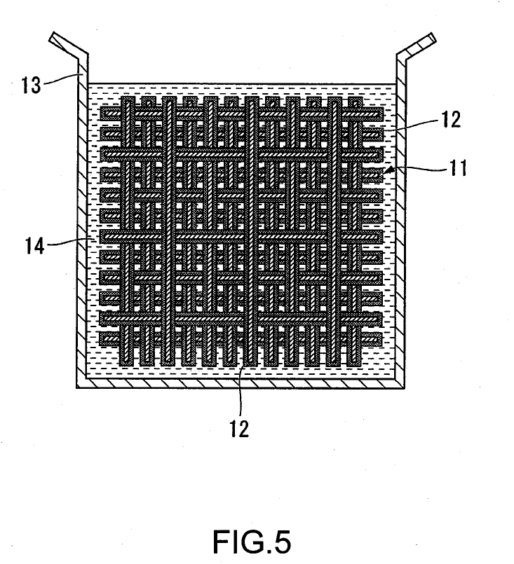

After the titanium oxide layer 12 has been formed at the outer layer of the metal woven fabric body 11 in this manner, the metal woven fabric body 11 is submerged in a lithium salt aqueous solution 14 in a treatment container 13, as shown in FIG. 5. The lithium aqueous solution is an aqueous solution containing Li that is a material for forming the active material (the active material layer 3), and an aqueous solution of, for example, LiOH, LiC1 or the like may be used. However, as a hydrothermal synthesis reaction to be conducted later may preferably be conducted in a strong alkali environment, LiOH (lithium hydroxide) solution is more favorably used, and therefore, in accordance with the present embodiment, LiOH (lithium hydroxide) aqueous solution is used. It is noted that, as the treatment container 13, a container coated with fluorocarbon polymers may preferably be used.

The concentration and the amount of the LiOH aqueous solution may be adjusted such that, when lithium titanate to be generated by having the LiOH aqueous solution reacted with the titanium oxide layer 12 is Li₄Ti₅O₁₂, the molar ratio of Li/Ti becomes to be 0.8 or greater with respect to the amount of Ti in the titanium oxide layer 12. Alternatively, when lithium titanate to be generated is LiTiO₂, the concentration and the amount of the LiOH aqueous solution may be adjusted such that the molar ratio of Li/Ti becomes to be 1 or greater with respect to the amount of Ti in the titanium oxide layer 12.

Furthermore, the concentration of the LiOH aqueous solution may preferably be adjusted to have pH of 10 or greater, and more preferably 13 or greater. By so doing, at the time of hydrothermal synthesis reaction to be conducted later, titania composing the titanium oxide layer 12 would dissolve in high-temperate, high-pressure water, whereby active material composed of lithium titanate are more favorably generated.

Then, the treatment container 13 in which the metal woven fabric body 11 is submerged in the lithium salt aqueous solution 14 is placed in an autoclave, where hydrothermal synthesis reaction is conducted at 180° C. for 24 hours. As the metal woven fabric body 11 is placed in a high-temperature and high-pressure environment in the autoclave, as well as in the strong alkali environment, the titanium oxide layer (titania layer) 12 at the outer layer of the metal woven fabric body 11 chemically reacts with LiOH (lithium hydroxide), thereby generating lithium titanate. In other words, being placed in the high-temperature and high-pressure environment as well as in the strong alkali environment, part of the titania dissolves in the LiOH aqueous solution, and Ti is substituted by Li, and the titania becomes to be lithium titanate such as Li₄Ti₅O₁₂, LiTiO₂, or the like.

By this, the metal woven fabric body 11 generates active material composed of lithium titanate, because the titanium oxide layer 12 at the outer layer of the metal woven fabric body 11 is hydrothermally reacted (chemically reacted) through the hydrothermal synthetic treatment. In other words, as shown in FIG. 1, the active material layer 3 is formed in a manner to cover the surface of the metal woven fabric body 6 composed of the central portions of the metal woven fabric bodies 11.

In this manner, the active material body 4 composed of the metal woven fabric body 6 with the active material layer 3 formed on the surface thereof is abutted and fixed to one of the surfaces of the collector electrode 2 using conductive binder, and other active material bodies 4 are further laminated thereon, whereby the lithium battery electrode 1 in accordance with the embodiment of the invention is obtained.

According to the lithium battery electrode 1 obtained in this manner, the active material layer 3 is disposed on the surface of the metal woven fabric body 6 composed of metal bodies having a wiring shape thereby covering the metal woven fabric body 6, such that electrons generated in the electrode reaction in the active material layer 3 are transferred through the central sections that are not chemically changed (not oxidized) in the metal woven fabric body 11 and well collected by the collector electrode 2. Accordingly, the utilization factor of the active material is higher, compared to ordinary electrodes of related art, and the lithium battery 10 using the battery electrodes 1 shown in FIG. 2 can achieve higher power output.

As the active material layer 3 covers the metal woven fabric body 6, the amount of the active material with respect to the metal bodies having a wiring shape 5 increases, whereby a lithium battery using the electrodes 1 can achieve higher power output and greater capacity. Furthermore, as the metal woven fabric body 6 (11) composed of the metal bodies having a wiring shape 5 is used, the flow of electrons among the metal bodies having a wiring shape 5 are not obstructed such that the metal bodies having a wiring shape 5 readily become conductively connected to one another, and electrons generated in the electrode reaction in the active material layer 3 are transferred through the metal bodies having a wiring shape 5 and more excellently collected by the collector electrode 2. Also, as the metal bodies having a wiring shape are formed into a woven fabric whose handling is easy, manufacturing of the lithium battery 10 becomes easier. It is noted that the utilization factor of active material refers to a rate of the amount of electricity that can be retrieved in actual discharge, when the amount of electricity to be obtained when the charged active material is thoroughly utilized is 100%.

Also, according to the method for manufacturing the lithium battery electrode 1, the electrode 1 can be readily manufactured, and the active material layer 3 can be formed and disposed on the surface of the metal woven fabric body 6 composed of the metal bodies having a wiring shape 5 in a manner to cover the surface and in one piece with the metal woven fabric body 6, such that high mechanical strength can be added to the electrode 1 obtained.

Also, in the lithium battery 10 shown in FIG. 2, electrons generated in the electrode reaction in the active material are transferred through the metal bodies having a wiring shape 5 and are collected well by the collector electrode 2, in other words, the lithium battery 10 is equipped with the lithium battery electrodes 1 with a large utilization factor of active material, such that a higher power output can be achieved. Also, the active material bodies 4 are laminated in plural layers, whereby a larger capacity can be achieved.

Accordingly, the lithium batteries 10 are favorably used in portable electronic apparatuses, such as, cellular phones, notebook computers and the like, and can also be used for electric vehicles. It is noted that the electrodes for lithium batteries and lithium batteries in accordance with the invention are not limited to the embodiments described above, and many changes can be made within the range that does not depart from the subject matter of the invention.

1-17. (canceled)

18. An electrode of lithium battery, comprising:
a metal body that has a wiring shape; and
a layer of active material disposed on a surface of the metal body.

19. The electrode of lithium battery according to claim 18, the active material covering the metal body.

20. The electrode of lithium battery according to claim 18, the metal body containing titanium.

21. The electrode of lithium battery according to claim 18, the active material including a lithium titanate.

22. The electrode of lithium battery according to claim 18, the metal body forming a woven fabric.

23. The electrode of lithium battery according to claim 18, the metal body having a diameter of 1 μm or greater.

24. The electrode of lithium battery according to claim 22, a stack of a plurality of woven fabrics being laminated to a collector electrode.

25. A method of manufacturing an electrode of a lithium battery, comprising:
forming a metal oxide on a metal body having a wiring shape; and
forming an active material on the metal body by hydrothermal reaction of the metal oxide.

26. The method of manufacturing an electrode of a lithium battery according to claim 25,
the forming of the metal oxide being performed by oxidizing the metal body by an anodic oxidization method,
the forming the active material being performed by submerging the metal body in an aqueous solution including the active material or a material of forming the active material to cause the hydrothermal reaction of the metal oxide.

27. The method of manufacturing an electrode of lithium battery according to claim 26, the active material covering the metal body.

28. The method of manufacturing an electrode of lithium battery according to claim 26, the metal body containing titanium.

29. The method of manufacturing an electrode of lithium battery according to claim 26, the aqueous solution being a lithium salt aqueous solution, the active material including a lithium titanate.

30. The method of manufacturing an electrode of lithium battery according to claim 29, the lithium salt aqueous solution having pH of 10 or greater.

31. The method of manufacturing an electrode of lithium battery according to claim 26, the metal body forming a woven fabric.

32. The method of manufacturing an electrode of lithium battery according to claim 26, the metal body having a central section that has a diameter of 1 μm or greater, the central section being unoxidized by the anodic oxidation method.

33. A lithium battery comprising the electrode of lithium battery according to claim 18.
